(19) United States
(12) Patent Application Publication
(10) Pub. No.: US 2022/0392303 A1
(43) Pub. Date: Dec. 8, 2022

(54) GAMING DEVICE AND METHOD FOR ENHANCED START OF GAME OPERATIONS

(71) Applicant: KING SHOW GAMES, INC., Minnetonka, MN (US)

(72) Inventor: Jacob LAMB, Maple Grove, MN (US)

(21) Appl. No.: 17/835,957

(22) Filed: Jun. 8, 2022

Related U.S. Application Data
(60) Provisional application No. 63/208,063, filed on Jun. 8, 2021.

(51) Int. Cl. G07F 17/32; G07F 17/34

(52) U.S. Cl. CPC G07F 17/3227; G07F 17/34

(57) ABSTRACT

Embodiments of the present invention set forth systems, apparatuses and methods for enhancing the beginning of game operations on gaming devices. Accordingly, a gaming device can be configured to operate a video poker gaming event including randomly determining a sequence of virtual playing cards to use in the video poker gaming event from a deck of virtual playing cards stored in the memory of the gaming device and repeating a process starting at the first virtual card of the sequence, and continuing therefrom if necessary, whether that virtual playing card meets a predefined condition. If that virtual card is determined to meet the predefined condition, the processor deals that virtual card to the first card position on the display of the gaming device and the following virtual cards in the randomly determined sequence to complete a dealt poker hand.

### RELATED APPLICATIONS

This application claims the benefit of Provisional Patent Application No. 63/208,063, filed on Jun. 8, 2021, to which priority is claimed pursuant to 35 U.S.C. § 119(e) and which is incorporated herein by reference in its entirety.

### FIELD OF THE INVENTION

This disclosure relates generally to games, and more particularly to systems, apparatuses and methods for enhancing the beginning of game operations on gaming devices.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes methods, systems, and apparatus that provide for new and interesting gaming experiences, and that provide other advantages over the prior art.

### SUMMARY

To overcome limitations in the prior art described above, and to overcome other limitations that will become apparent upon reading and understanding the present specification, embodiments of the present invention are directed to an apparatus, system, computer readable storage media, and/or method that involve or otherwise facilitate enhancing the beginning of game operations on gaming devices. In one embodiment, a gaming device having a display, user interface, wager input device, memory and processor is operable to play a video poker gaming event upon receipt of a wager and game initiation signal. The processor of the gaming device is configured to operate the video poker gaming event including randomly determining a sequence of virtual playing cards to use in the video poker gaming event from a deck of virtual playing cards stored in the memory of the gaming device. The processor is further configured to determine, starting at the first virtual card of the randomly determined sequence, whether that virtual playing card meets a predefined condition. If that virtual card is determined to meet the predefined condition, the processor deals that virtual card to the first card position on the display of the gaming device and the following virtual cards in the randomly determined sequence to complete a dealt poker hand. If that virtual card is determined to not meet the predefined condition, however, the processor moves to the next virtual card in the sequence to determine if that next card meets the predefined condition. This process is repeated until one of the virtual cards in the randomly determined sequence meets the predefined condition, at which point that card and the next plurality of cards from the randomly determined sequence are displayed on the display to form a dealt poker hand. In some embodiments, if a predetermined number of cards in the randomly determined sequence do not meet the predefined condition, a hand modifier (such as a multiplier) may be awarded for the poker hand. These and other embodiments are described in more detail along with variations below in conjunction with the drawings.

### BRIEF DESCRIPTION OF THE DRAWINGS

FIG. 1 is a diagram of a gaming machine according to embodiments of the invention.

FIG. 2 is a block diagram illustrating a computing arrangement according to embodiments of the invention

FIG. 3 is a detail diagram of a gaming device display showing an enhanced start feature according to embodiments of the invention.

FIGS. 4A, 4B, 4C, 4D, and 4E are a detail diagram of a gaming device display showing a game progression having an enhanced start feature according to embodiments of the invention.

FIGS. 5A, 5B, 5C, 5D, 5E, 5F, 5G, and 5H are detail diagrams of a gaming device display showing a game progression according to embodiments of the invention.

FIGS. 6A, 6B, 6C, 6D, 6E, and 6F are detail diagrams of a gaming device display showing another game progression according to embodiments of the invention.

FIG. 7 is a detail diagram of a gaming device display showing an enhanced start feature according to embodiments of the invention.

FIG. 8 is a detail diagram of a gaming device display showing an enhanced start feature according to embodiments of the invention.

FIGS. 9A, 9B, 9C, 9D, 9E, 9F, 9G, 9H, and 9I are detail diagrams of a gaming device display showing a game progression according to embodiments of the invention.

FIG. 10 is a block diagram of a representative gaming apparatus for providing an enhanced start feature according to embodiments of the invention.

FIGS. 11A and 11B are detail diagrams of a gaming device display showing a game progression according to embodiments of the invention.

FIGS. 12A and 12B are detail diagrams of a gaming device display showing a game progression according to embodiments of the invention.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatus.

In various embodiments of the invention, the gaming displays are described in conjunction with the use of data in the form of “symbols.” In the context of this disclosure, a “symbol” may generally refer at least to a collection of one or more arbitrary indicia or signs that have some conventional significance. In particular, the symbol represents values that can at least be used to determine whether to award a payout. A symbol may include numbers, letters, shapes, pictures, textures, colors, sounds, etc., and any combination therebetween. A win can be determined by comparing the symbol with another symbol. Generally, such comparisons can be performed via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for enhancing the beginning of game operations in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. video poker game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that utilizes operations of enhancing the beginning of game operations on gaming devices. In one embodiment, a gaming device having a display, user interface, wager input device, memory and processor is operable to play a video poker gaming event upon receipt of a wager and game initiation signal. The processor of the gaming device is configured to operate the video poker gaming event including randomly determining a sequence of virtual playing cards to use in the video poker gaming event from a deck of virtual playing cards stored in the memory of the gaming device. The processor is further configured to determine, starting at the first virtual card of the randomly determined sequence, whether that virtual playing card meets a predefined condition. If that virtual card is determined to meet the predefined condition, the processor deals that virtual card to the first card position on the display of the gaming device and the following virtual cards in the randomly determined sequence to complete a dealt poker hand. If that virtual card is determined to not meet the predefined condition, however, the processor moves to the next virtual card in the sequence to determine if that next card meets the predefined condition. This process is repeated until one of the virtual cards in the randomly determined sequence meets the predefined condition, at which point that card and the next plurality of cards from the randomly determined sequence are displayed on the display to form a dealt poker hand. In some embodiments, if a predetermined number of cards in the randomly determined sequence do not meet the predefined condition, a hand modifier (such as a multiplier) may be awarded for the poker hand. These and other embodiments are described in more detail along with variations below in conjunction with the drawings.

Numerous variations are possible using these and other embodiments of the inventive concept. Some of these embodiments and variations are discussed below with reference to the drawings. However, many other embodiments and variations exist that are covered by the principles and scope of this concept. For example, although some of the embodiments discussed below involve video poker machine examples of this concept, other embodiments include application of these inventive techniques in other types of poker games, slot games, or other games of chance. Some of these other types of embodiments will be discussed below as variations to the examples illustrated. However, many other types of games can implement similar techniques and fall within the scope of this inventive concept.

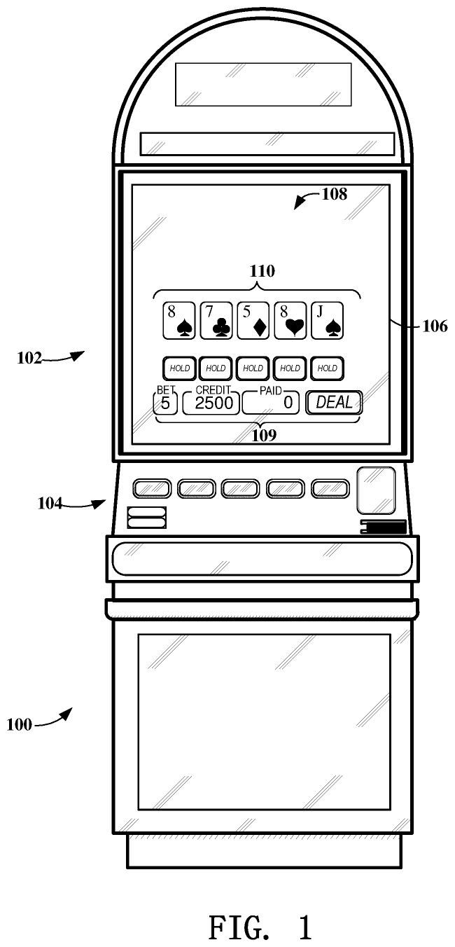

Referring to the example gaming apparatus 100 shown in FIG. 1, the gaming apparatus includes a display area 102 (also referred to as a gaming display), and a player interface area 104, although some or all of the interactive mechanisms included in the user interface area 104 may be provided via graphical icons used with a touch screen in the display area 102 in some embodiments. The display area 102 may include one or more game displays 106 (also referred to as “displays” or “gaming displays”) that may be included in physically separate displays or as portions of a common large display. Here, the game display 106 includes a primary game play portion 108 that displays game elements and symbols 110, and an operations portion 109 that can include meters, various game buttons, or other game information for a player of the gaming device 100.

The user interface 104 allows the user to control and engage in play of the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, or any other user input system or mechanism that allows the user to play the particular gaming activity. In video poker embodiments, for example, the user interface 104 may include five physical buttons that correspond to displayed card positions and allow a player to hold (or un-hold) particular cards in a draw poker hand. The user interface 104 may also include a physical “Deal/Draw” button that allows a player to initiate a new game by having cards dealt to the card positions or draw replacement cards after having the opportunity to hold any of the dealt cards. In other poker games, keno games, slot games, or other games of chance different button panels or configurations may be used.

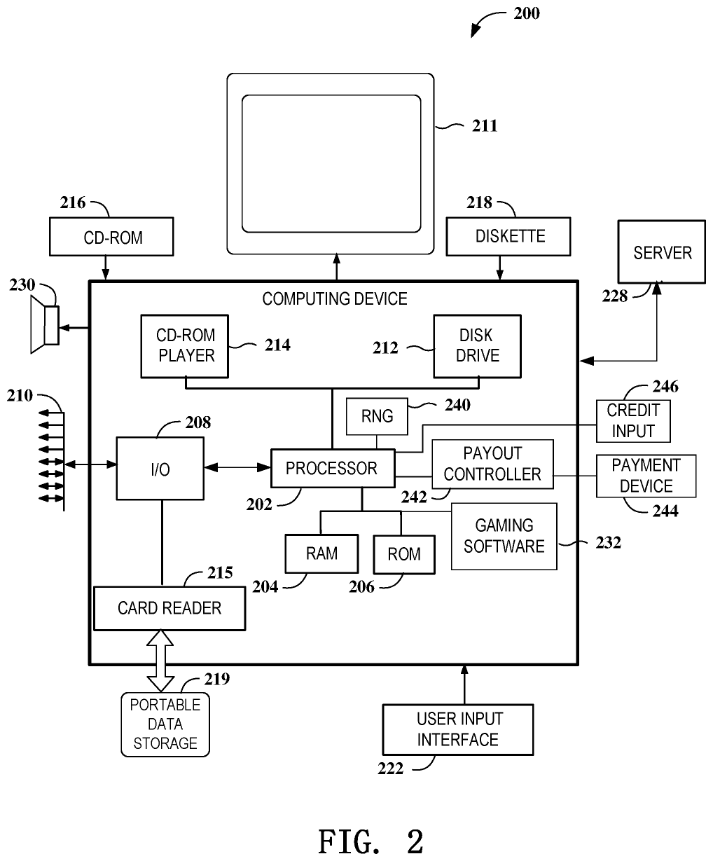

The user interface 104 may allow the user or player to enter coins, bills, or otherwise obtain credits through vouchers, tokens, credit cards, tickets, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player loyalty information to identify a user or player of the gaming device. This mechanism may be card reader, biometric scanner, keypad, or other input device. It is through the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel on the gaming machine 100 and/or graphical images. The symbols or other indicia associated with the play of the game may be presented on an electronic display device or on mechanical devices associated with a mechanical display. Generally, the display 106 devotes the largest portion of viewable area to the primary gaming portion 108. The primary gaming portion 108 is generally where the visual feedback for any selected game is provided to the user. The primary gaming portion 108 may render graphical objects such as cards, slot reels, dice, animated characters, and any other gaming visual known in the art. The primary gaming portion 108 also typically informs players of the outcome of any particular event, including whether the event resulted in a win or loss.

In some of the example embodiments illustrated herein, the primary gaming portion 108 may display a grid (or equivalent arrangement) of playing cards 110 forming a hand. Here, the grid includes a row of five playing cards 110 forming a video poker hand, which represents a portion of a game play event. For example, if the game play event is a video draw poker game, the gaming device 100 may deal five cards, allow the user to select which cards to hold, deal replacements for the cards not held, and determine a payout based on the final cards in the hand. The illustration and description of five-card-draw poker is for purposes of example and not of limitation; the present invention may be applicable to numerous other card games, such as stud poker or hold 'em poker, as well as other types of gaming activities and apparatuses, such as slot machines, dice, coins, etc.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual cards for holding prior to draw of new cards. The game display 106 of the display area 102 may include other features that are not shown, such as paytables, navigation controls, etc.

In other example embodiments, the primary gaming portion 108 may display a grid (or equivalent arrangement) of game elements or game element positions (also referred to as “reel stop positions” herein). Although not shown in FIG. 1, the grid may include three rows and five columns of game elements, which may form a game outcome of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

Although FIG. 1 illustrates a particular implementation of some of the embodiments of this invention in a casino or electronic gaming machine (“EGM”), one or more devices may be programmed to play various embodiments of the invention. The present invention may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the invention is illustrated in FIG. 2.

Hardware, firmware, software or a combination thereof may be used to perform the various gaming functions, display presentations and operations described herein. The functional modules used in connection with the invention may reside in a gaming machine as described, or may alternatively reside on a stand-alone or networked computer. The computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions in accordance with the present invention typically includes a central processor (CPU) 202 coupled to random access memory (RAM) 204 and some variation of read-only memory (ROM) 206. The ROM 206 may also represent other types of storage media to store programs, such as programmable ROM (PROM), erasable PROM (EPROM), etc. The processor 202 may communicate with other internal and external components through input/output (I/O) circuitry 208 and bussing 210, to provide control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to the display 211, which represents a display on which the gaming activities in accordance with the invention are presented. The display 211 represents the “presentation” of the game information in accordance with the invention, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, or inputting data to identify a player for a player loyalty system. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG). The fixed and dynamic symbols generated as part of a gaming activity may be produced using one or more RNGs. RNGs may be implemented using hardware, software operable in connection with the processor 202, or some combination of hardware and software. The present invention is operable using any known RNG, and may be integrally programmed as part of the processor 202 operation, or alternatively may be a separate RNG controller 240. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout device 244 may also be provided in gaming machine embodiments, where the payout device 244 serves as the mechanism providing the payout to the player or participant. In some embodiments, the payout device may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payout device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described hereinabove. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

As indicated above, embodiments of the invention are directed to gaming devices and methods of operating gaming devices to play gaming events where an enhanced game starting process is provided to increase the entertainment, and hence the desirability, of the gaming devices. According to some embodiments, a video poker gaming event may be implemented on the gaming device where the first card of a dealt poker hand is guaranteed to meet a predefined condition. For example, the first card may have to meet the predefined condition of being an ace or “face” card (“face” card meaning any royal card of jack, queen, or king). This may be desirable as in most standard video poker games the minimum winning hand is a pair of jacks or better. Hence, receiving at least a royal or ace card in the first position guarantees a card in the dealt hand that the player can hold toward a winning hand (instead of, for example receiving five non-matching low cards on the deal that the player has to entirely discard). This enhanced start feature may lead to more a higher frequency of winning outcomes and hence, more enjoyment of the video poker game. This may be in part, also due to the elimination of “dead” hands where the player has to draw all new cards, which have a relatively low win frequency. To compensate for the additional odds of receiving a winning hand, this feature may require a side wager (or bonus bet as part of the total wager), or may used a different paytable.

To further enhance the excitement of this example game, some embodiments may further include a process where after the player receives a predetermined number of cards that do not meet the predefined condition, each additional card dealt to the first position may cause a bonus modifier to become active (such as implementing a multiplier) that is then used with the hand when it is finally dealt. In the case of the bonus modifier being a multiplier, the multiplier may be incremented or otherwise increased for each additional card over the predetermined number of cards needed to reach an ace or face card to deal to the first card position. In other embodiments, other types of modifiers may also be incremented as additional cards are needed to deal an ace or face card (or whatever card is needed to satisfy the predefined condition) to the first card position. In other embodiments, the bonus modifier may be randomly awarded after the predetermined number of cards has been reached. In yet other embodiments, there may not be a predetermined number of cards needed for the bonus modifier to be implemented. That is, the bonus modifier may be randomly awarded, may be randomly improved, or may be awarded as soon as a single card is skipped over as not meeting the predefined condition. For example, each time a card is determined to not meet the predefined condition, a random determination may be made as to whether a bonus modifier will be awarded for the poker hand.

In some embodiments, awarded bonus modifiers are used with a poker hand in a current gaming event. However, in other embodiments, the awarded bonus modifier may be used in a next gaming event (either with or without also using it in the current gaming event), or the bonus modifier may be active for a random or predetermined number of future hands, for a random amount of time, or until it can be used with a winning poker hand. In embodiments that have multiple poker hands in the same poker gaming event, each of the multiple poker hands may have independent bonus modifiers associated with each poker hand, or a single bonus modifier may be used to modify each of the multiple poker hands. For example, in embodiments where the bonus modifier is a multiplier, if the bonus modifier is activated on a first dealt hand, it will apply to each final poker hand for each of the multiple poker hands.

To accomplish some of there embodiments, a gaming device may be configured to randomly determine a sequence of virtual playing cards to use for a particular poker hand. The gaming device may then examine the first card in the random sequence to determine if that card meets a predefined condition. As mentioned above, this predefined condition may be that the examined card is an ace or face card. However, in other embodiments, any predefined condition may be used—such as the card being a particular rank (e.g., a deuce), a particular suit (e.g., a spade), a joker, an extra bonus card shuffled or otherwise randomized with the virtual playing cards in the sequence, a range using any of the criteria above, and other possible game attributes that could be used as defining a predefined condition associated with one or more dealt cards.

If the first card examined in the random sequence does not meet the predefined condition, then the next card in the sequence is examined in a similar process to determine if that next card meets the predefined condition. This process may be repeated until a card in the sequence does satisfy the predefined condition. In yet other embodiments, multiple cards may have to meet a predefined condition before proceeding with the gaming event (for example, two cards of the same suit are dealt, a pair of cards are dealt, etc.). Once a card in the random sequence satisfies or otherwise meets the predefined condition, the next cards in the sequence may then be used to fill in the rest of the card positions in the dealt poker hand. Although some of the examples above focus on draw poker gaming events, other embodiments using stud poker hands, or other types of gaming events, such as blackjack, slots, or keno can use similar techniques to those outlined herein.

The cards that are examined from the sequence may be shown to the player, may not be perceptible to the player, or may have a counter or other meter so the cards are not shown to the player, but there is an indication of what number card in the sequence was reached before the first card(s) met the predefined condition. This choice may be made by game designers so as not to influence the poker strategy of the player. For example, if the player noticed that the five of hearts and five of spades were examined and bypassed initially, and then they were dealt a hand with the five of diamonds and five of clubs, the player may go against conventional poker strategy and not hold the two dealt fives since she would already know that there was no chance of drawing another one or two fives. In some embodiments, the cards that were initially examined in the sequence and bypassed for not meeting the predefined condition may be randomly inserted back into the sequence so all card combinations remain possible. In yet other embodiments, two virtual decks using two random sequences may be used, where the first deck is used to determine the first card or cards needed to satisfy the predefined condition, and the second deck is then used to determine the next cards dealt and held (with the card(s) meeting the predefined condition removed from the second sequence from the second deck of cards). In this embodiment, for example, the first deck may be used to determine the initial card or cards in the poker hand using the predefined condition specified for the game. Once those initial card or cards were determined and dealt to the poker hand, those dealt cards may be removed from a second deck of cards, which then may be used to randomly deal the remaining cards to the poker hand without influencing the poker strategy of the player.

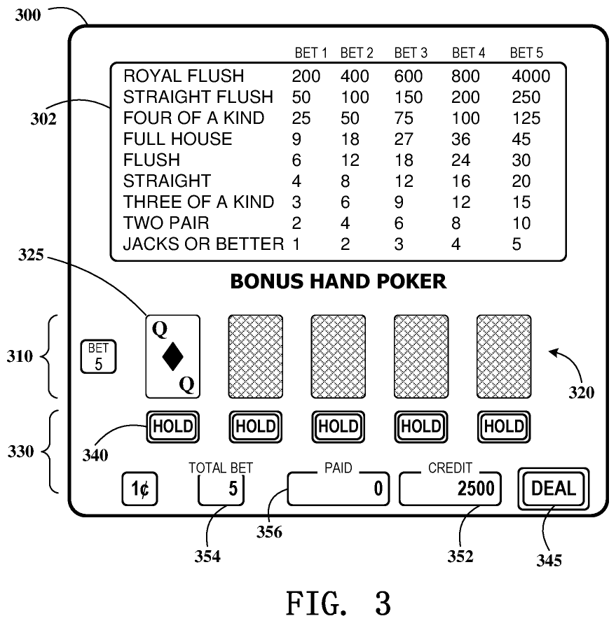

FIG. 3 is a detail diagram of a gaming device display 300 included in a gaming device having an enhanced start feature according to embodiments of the invention. This gaming display device 300 may be configured to display a poker paytable 302 showing various possible awards associated with possible poker hands, a game play area 310 configured to display a grid of card positions making up one or more poker hands 320 as part of the poker game, and a player interface area 330 showing various buttons, meters, and/or information to allow the player to interact with the poker game on the gaming device. The player interface area 330 may, for example, include a plurality of Hold buttons 340 associated with each card in the poker hand 320 (if the poker game was a draw poker game), a Deal/Draw button 345 used to infinite a new poker game and indicate when the player has held the desired cards and is ready to draw new cards to any card positions where the previous cards were not held, a Credit meter 352 showing an available credit amount (that may be stored in the memory of the gaming device) for the player to use to place wagers on poker games, a Total Bet meter 354 showing an amount of a total wager or bet on a particular poker game or game event, and a Paid meter 356 showing a total award amount won based on a played poker game or game event. In other embodiments, additional or fewer buttons or meters may be present on the gaming device display 300. In addition, or alternatively, separate meters and/or physical buttons may be included in a player interface portion of the gaming device that is separate from the gaming device display.

In this embodiment shown in FIG. 3, a card dealt to the first card position 325 of the poker hand 320 must be an ace or a face card. That is, once a player inserts money into the gaming device and places a wager on a first poker game, a processor in the gaming device randomly determines (using, in some embodiments, a separate random number generator) a sequence of cards from a virtual deck of cards stored in the memory of the gaming device. The processor may then examine the sequence of cards to determine if the first card meets the predefined criteria (here being an ace or face card). If that first card meets the predefined condition or criterion, that card is dealt to the first card position 325 of the poker hand 320. If that first card in the sequence does not meet the predefined condition, the processor may then move to the second card in the random sequence to determine if that second card meets the predefined condition. This examination process may continue in a sequential manner until an examined card in the random sequence of cards satisfies the predefined condition, at which point it will be dealt to the first card position 325 of the poker hand 320.

In some embodiments, the random sequence of cards generated by the processor may be an actual random ordering of virtual cards (i.e., 5C, 10D, 6S, QH, etc.), while in other embodiments, this random sequence may simply be a random list of pointers or other data structures pointing to ordered deck of virtual playing cards stored in the memory of the gaming device. Further, the random sequence may be entirely predetermined for at least a portion of the deck of virtual cards (up to providing a sequence for the entire deck of virtual cards) prior examining any cars in the sequence of cards is some embodiments. However, in other embodiments, the random sequence may be built during game play. That is, each virtual card for the sequence may only be randomly determined on a need basis. So the second virtual card in the random sequence may not be determined until a first random card is examined to determine if it satisfies the predefined condition. Other potential methods of generating the random sequence of cards are contemplated for other embodiments.

Once the virtual card that met the predefined condition is dealt to the first card position 325 of the poker hand 320, the processor may then deal virtual cards to the remaining card positions in the poker hand to complete a dealt poker hand. The poker game may then be played by the player by, for example, holding cards and drawing new cards to complete a final poker hand. The final poker hand may then be evaluated by the processor to determine if that final poker hand of cards is associated with an award as specified by the paytable 302 (shown on the display 300 and kept in the gaming device memory). Any awards won during the poker game may then be shown in the Paid meter 356 and added to the credit amount stored in the memory and shown on the Credit meter 352.

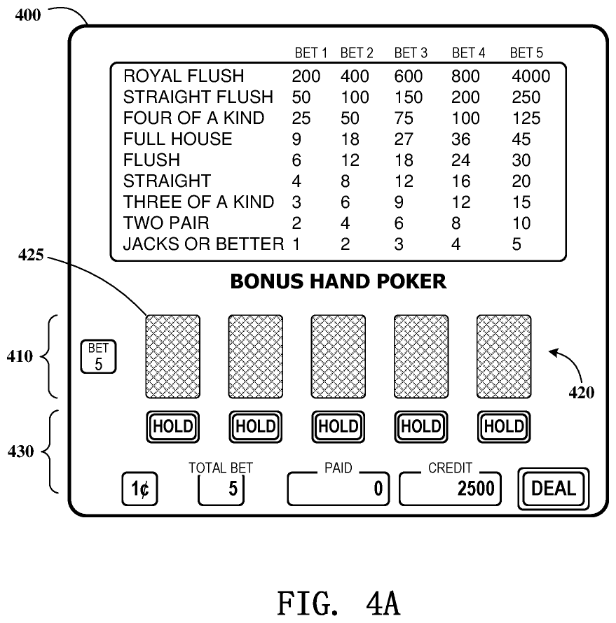

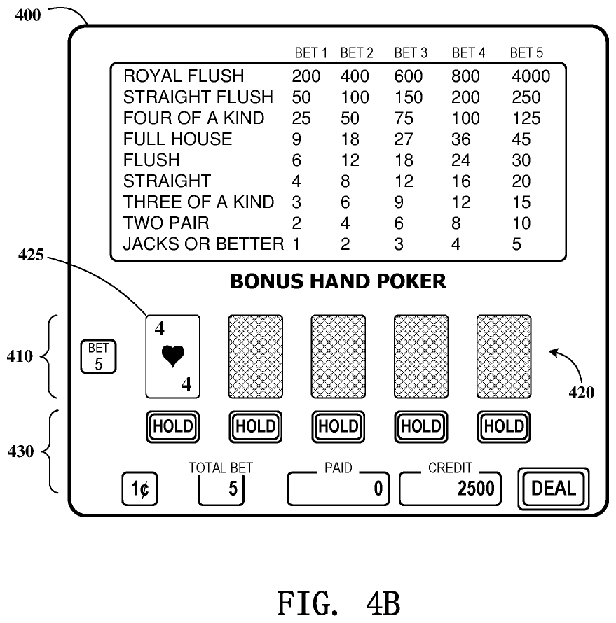

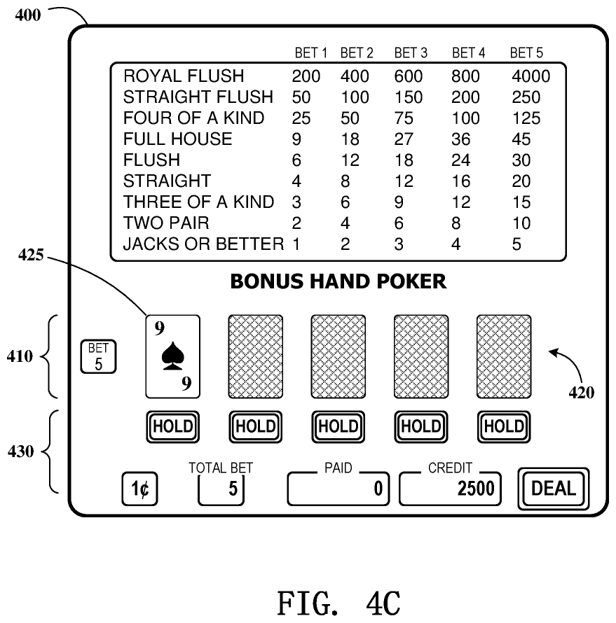

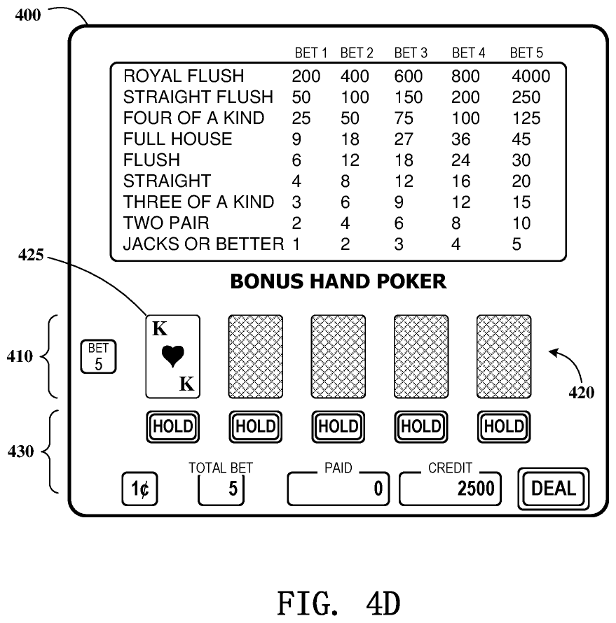

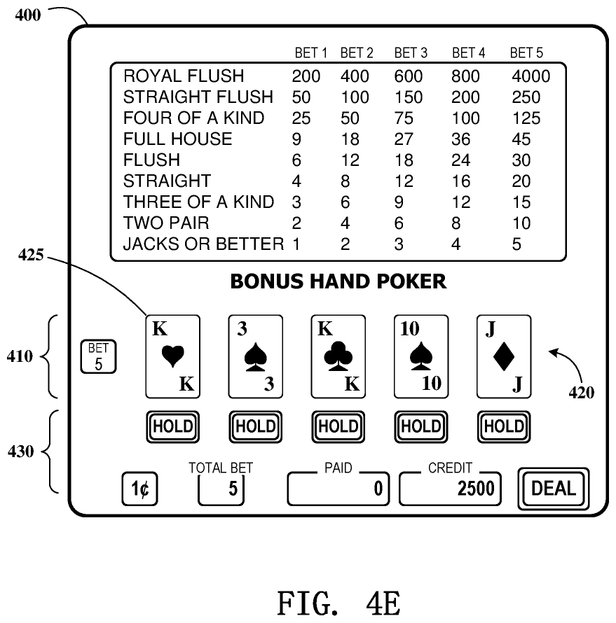

FIGS. 4A, 4B, 4C, 4D, and 4E are detail diagrams of a gaming device display showing a game progression having an enhanced start feature according to embodiments of the invention. This game progression illustrates a game event where the first two cards in a random sequence do not meet the predefined condition of being an ace or face card. However, after the third card of the sequence satisfies the predefined condition, the virtual cards making up the dealt poker hand are displayed and the poker game can be played.

Referring to FIG. 4A, a gaming device display 400 includes a game play area 410 configured to display a grid of card positions making up one or more poker hands 420 as part of the poker game, and a player interface area 430 showing various buttons, meters, and/or information to allow the player to interact with the poker game on the gaming device. Here, the gaming device is configured so that the virtual card shown in the first card position 425 of the poker hand 420 must meet a predefined condition. In this particular embodiment, the predefined condition specifies that the virtual card in the first card position 425 must be an ace or face card, although in other embodiments any predefined condition or set of conditions may be used.

Referring to FIG. 4B, a first virtual card from a random sequence of cards is displayed in the first card position 425 and the processor determines if that first virtual card satisfies the predefined condition. In this case the 4 of Hearts (4H) is not an ace or face card. Hence, referring now to FIG. 4C, the 4H is removed from the first card position 425 (where it may be entirely discarded or randomly re-inserted in the random sequence of cards) and a second card from the random sequence is dealt to the first card position. In this case, the second card (9S) again does not satisfy the predefined condition. Hence, it is again removed and a third card (KH) is dealt to the first card position 425 as shown in FIG. 4D. This time, the KH card satisfies the predefined condition as it is a face card. As the predefined condition is now satisfied, the processor deals the next cards from the random sequence of cards to complete the card positions in the poker hand 420 to display a dealt poker hand as shown in FIG. 4E.

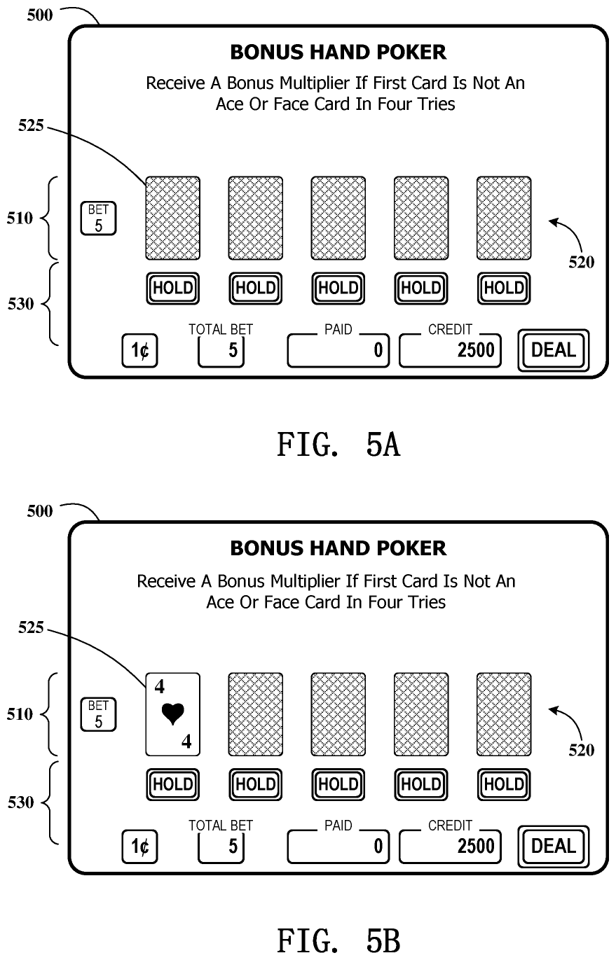

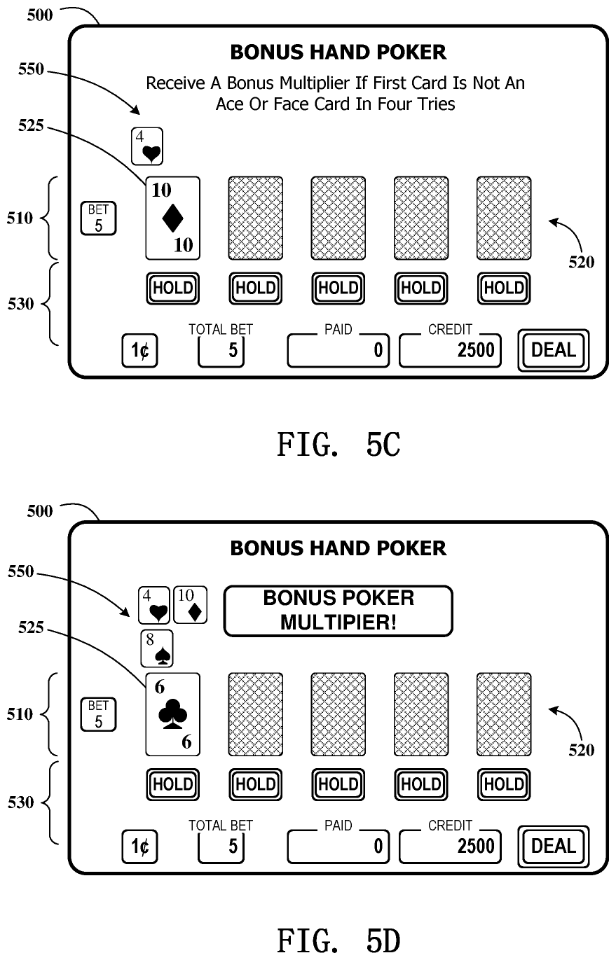

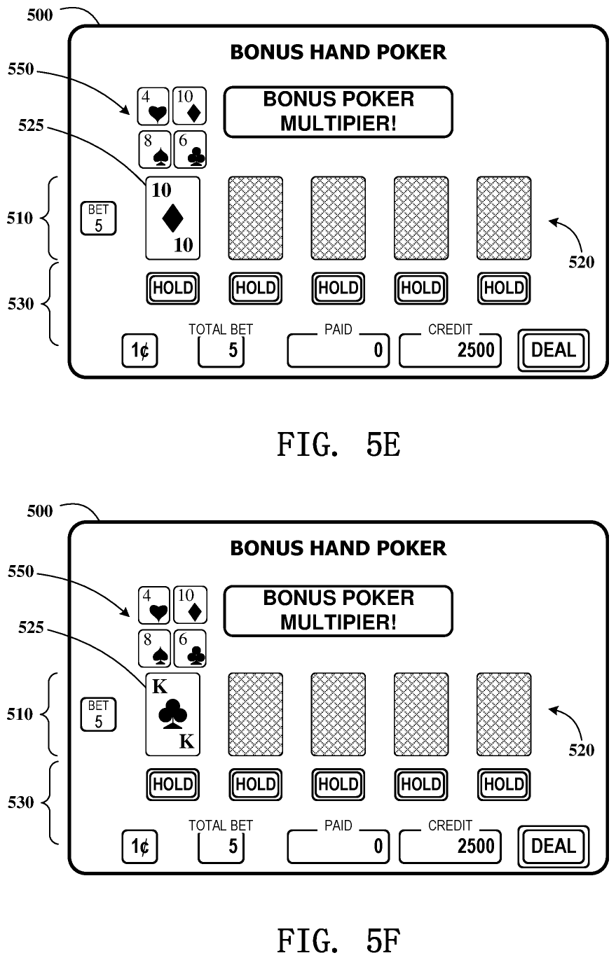

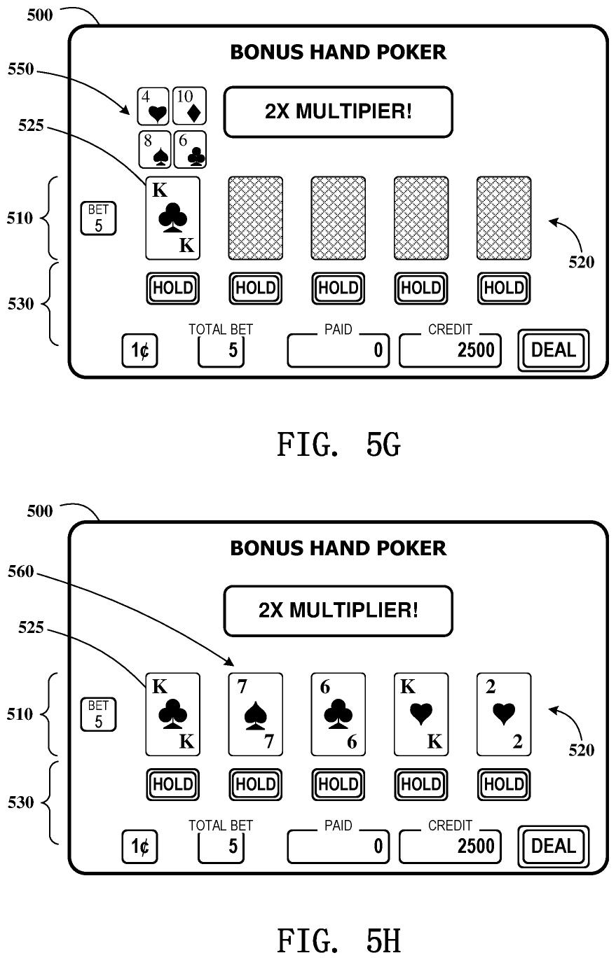

FIGS. 5A, 5B, 5C, 5D, 5E, 5F, 5G, and 5H are detail diagrams of a gaming device display showing a game progression according to embodiments of the invention. This game progression illustrates a bonus modifier (in this case a bonus multiplier) being implemented if a predetermined number of cards in the random sequence do not meet the predefined condition.

Referring to FIG. 5A, a gaming device display 500 includes a game play area 510 configured to display a grid of card positions making up one or more poker hands 520 as part of the poker game, and a player interface area 530 showing various buttons, meters, and/or information to allow the player to interact with the poker game on the gaming device. Here, the gaming device is configured so that the virtual card shown in the first card position 525 of the poker hand 520 must meet a predefined condition. In this particular embodiment, the predefined condition specifies that the virtual card in the first card position 525 must be an ace or face card. In addition, the poker game includes a bonus feature where if the first four cards in the random sequence are not ace or face cards a bonus multiplier will be determined and applied to any awards won based on the final poker hand of the poker game.

Referring to FIG. 5B, a first virtual card from a random sequence of cards is displayed in the first card position 525 and the processor determines if that first virtual card satisfies the predefined condition. In this case the 4 of Hearts (4H) is not an ace or face card. Hence, referring now to FIG. 5C, the 4H is removed from the first card position 525 and is now shown in a discard area 550 of the gaming display 500, and a second card from the random sequence is dealt to the first card position. In this embodiment, although the first card of the random sequence is shown in the discard area 550, it is also randomly re-inserted into the random sequence (where it may potentially be examined again against the predefined condition). In this case, the second card (10D) again does not satisfy the predefined condition. Hence, referring to FIG. 5D, the second card is removed from the first card position 525 and placed in the discard area 550. Additionally a third card (8S) and then a fourth card (6C) are dealt to the first card position 525 where the third card has already been examined and placed in the discard area 550. At this point, the first four cards of the random sequence have been examined and have not met the predefined condition. This in turn, triggers the awarding of a bonus multiplier as indicated by the messaging on the game display 500.

Referring to FIG. 5E, the fifth card (10D again after it had been randomly reinserted into the random sequence of cards) is shown in the first card position 525. As noted above, this card was previously received as the second card in the random sequence of cards so it already appears in the discard area 550 and need not be moved to that discard area again. The re-insertion of the previously-examined cards means that the poker strategy of a player does not need to change based on a card being examined and placed in the discard area 550 since it is randomly reinserted into the sequence of cards and may come up again depending on where in the sequence it is randomly inserted.

Referring to FIG. 5F, the next card in the random sequence (the sixth card examined) is the King of Clubs (KC), which satisfies the predefined condition as it is a face card. Referring to FIG. 5G, as the predefined condition is now satisfied, the processor randomly determines what the bonus multiplier will be for the poker game to heighten the anticipation of the player, which in this case is determined to be a 2× multiplier as shown on the game display 500. Note that in other embodiments, the bonus multiplier (or any bonus modifier) may be determined and/or revealed at a different time during the poker game (e.g., as soon as it is determined that a bonus modifier is to be awarded, after the final poker hand is displayed, or at some other time). After the bonus modifier has been determined, the processor deals the next cards from the random sequence of cards to complete the card positions in the poker hand 520 to display a dealt poker hand as shown in FIG. 5H.

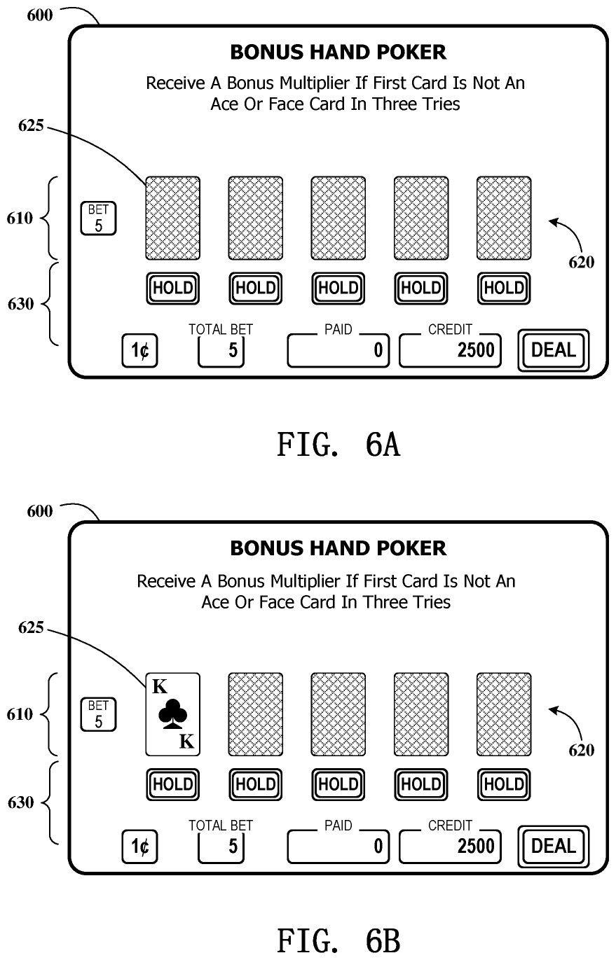

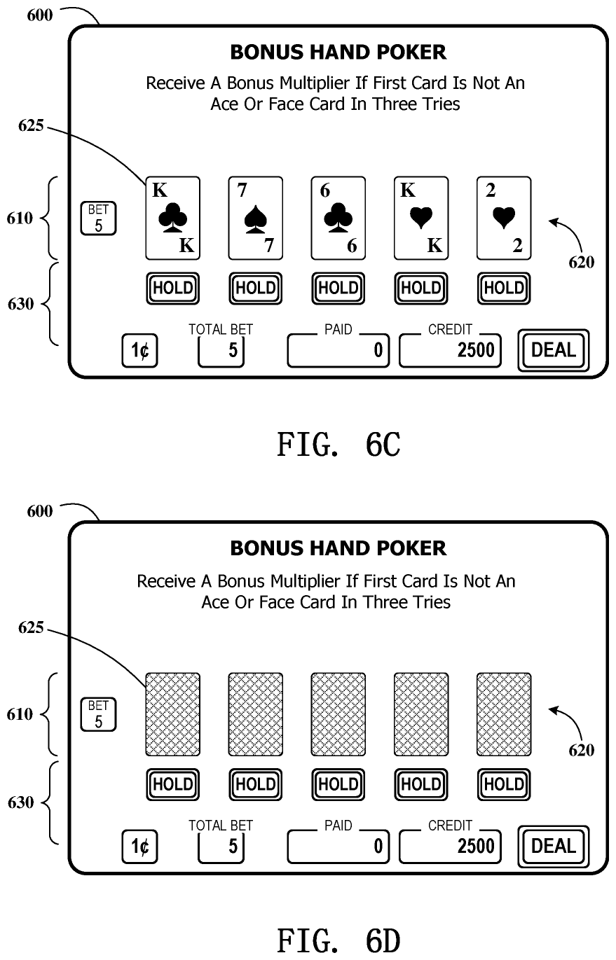

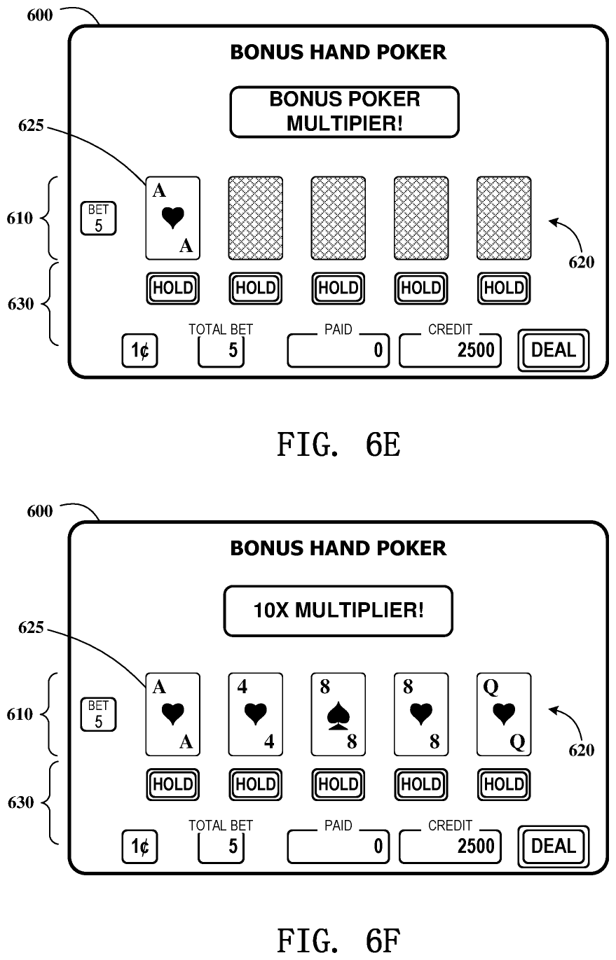

FIGS. 6A, 6B, 6C, 6D, 6E, and 6F are detail diagrams of a gaming device display showing another game progression according to embodiments of the invention. This game progression is similar to the one shown in FIGS. 5A-5H except the cards not used are not maintained and shown to the player in the discard area, and the bonus multiplier is incremented from a lower value to higher value with each card examined in the random sequence that does not meet the predetermined condition.

Referring to FIG. 6A, a gaming device display 600 includes a game play area 610 configured to display a grid of card positions making up one or more poker hands 620 as part of the poker game, and a player interface area 630 showing various buttons, meters, and/or information to allow the player to interact with the poker game on the gaming device. Here, the gaming device is configured so that the virtual card shown in the first card position 625 of the poker hand 620 must meet a predefined condition. In this particular embodiment, the predefined condition specifies that the virtual card in the first card position 625 must be an ace or face card. In addition, the poker game includes a bonus feature where if the first three cards in the random sequence are not ace or face cards a bonus multiplier will be initiated and incremented with each following examined card that does not meet the predefined condition, where the bonus multiplier once set will applied to any awards won based on the final poker hand of the poker game.

Referring to FIG. 6B, a first virtual card from a random sequence of cards is displayed in the first card position 625 and the processor determines if that first virtual card satisfies the predefined condition. In this case the King of Clubs (KC) is a face card and hence satisfies the predefined condition. Referring to FIG. 6C, as the predefined condition has been satisfied, the remaining card positions in the poker hand 620 are filled using the next cards in the random sequence of cards. Referring to FIG. 6D, another poker game (or gaming event) is initiated after the first poker gaming event shown in FIG. 6C has been completed. Referring to FIG. 6E, a number of cards have been dealt and examined to see if they satisfy the predefined condition. In this embodiment, the processes of examining the sequence of cards is not shown to the player or shown in a rapid fire sequence such that player does not observe what cards have been examined. Here, an Ace of Hearts (AH) is finally displayed in the first card position 625 as the AH was the first card in the random sequence to satisfy the predefined condition. Additionally, the gaming device indicates that a bonus multiplier is awarded as shown by the messaging on the game display 600. This means that more than three cards were examined in the card sequence before finding one that satisfied the predefined condition. The player, however, may not know how many cards were examined before finding a card that satisfied the predefined condition. In this particular embodiment, the player may figure out how many cards had been examined, as a 2× multiplier is awarded after the third card is determined not to satisfy the predefined condition and the bonus multiplier is incremented by 1× for each of the following examined cards that do not meet the predefined condition (although other incrementing methods including non-linear functions may be used in other embodiments). Here, as the bonus multiplier is revealed to be a 10× multiplier as shown in FIG. 6F, the player may deduce that twelve cards were examined before a card was examined that satisfied the predefined condition. Additionally, as shown in FIG. 6F, since the predefined condition is now satisfied, the remaining card positions in the poker hand 620 are filled with virtual cards to form a dealt poker hand for the second poker game.

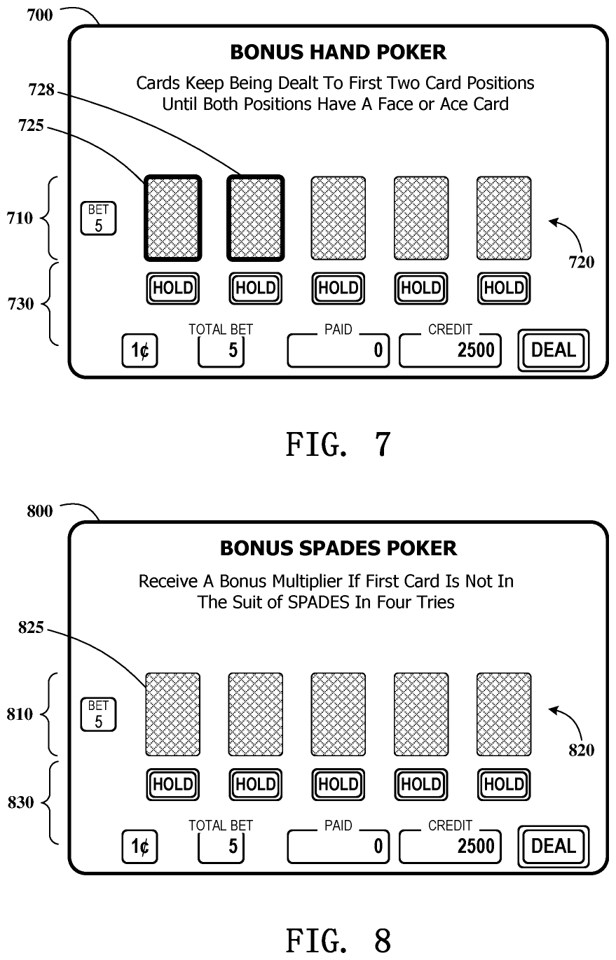

FIG. 7 is a detail diagram of a gaming device display showing an enhanced start feature according to embodiments of the invention. FIG. 7 illustrates an embodiment where the predefined condition applies to the first two card positions instead of just the first card position.

Referring to FIG. 7, a gaming device display 700 includes a game play area 710 configured to display a grid of card positions making up one or more poker hands 720 as part of the poker game, and a player interface area 730 showing various buttons, meters, and/or information to allow the player to interact with the poker game on the gaming device. Here, the gaming device is configured so that the virtual card shown in the first card position 725 of the poker hand 620 and the second card position 728 must meet a predefined condition. In this particular embodiment, the predefined condition specifies that the virtual cards in the first card position 725 and second card position 728 must both be ace or face cards. In other embodiments, different predefined conditions may be used, such as the cards in the first two card positions 725, 728 both being of the same suit, both being within one rank value of each other, or any other relationship that can be defined between two cards. In some embodiments, the processor may deal cards to the first card position 725 until a card is reached in the random sequence of cards that satisfies the condition for that cards position. The processor may then continue to examine the following cards in the random sequence for the second card position 728 until a card is found that also satisfies the predefined condition. In the example shown in FIG. 7, for example, the processor may examine cards in the random sequence until a first ace or face card is found, at which point that card would be placed in the first card position 725. The processor may then continue to examine cards in the random sequence until a second ace or face card is found, at which point that card would be placed in the second card position 728. In in embodiment where the cards had to match suit, the first card in the sequence may automatically be put in the first card position 725 and then the processor may examine the next cards in the sequence until a card is found that matches the suit of the card in the first card position 725. That next found card would then be displayed in the second card position 728. In other embodiments, different examination processes may be used to determine which cards to display in the first and second card positions 725, 728.

FIG. 8 is a detail diagram of a gaming device display showing an enhanced start feature according to embodiments of the invention. FIG. 8 illustrates an embodiment where the predefined condition is that the first card is a spade (as opposed to an ace or face card).

Referring to FIG. 8, a gaming device display 800 includes a game play area 810 configured to display a grid of card positions making up one or more poker hands 820 as part of the poker game, and a player interface area 830 showing various buttons, meters, and/or information to allow the player to interact with the poker game on the gaming device. Here, the gaming device is configured so that the virtual card shown in the first card position 825 of the poker hand 820 must meet a predefined condition. In this particular embodiment, the predefined condition specifies that the virtual card in the first card position 825 must be one of the spades cards. In addition, the poker game includes a bonus feature where if the first four cards in the random sequence are not spade cards a bonus multiplier will be applied to any awards won based on the final poker hand of the poker game. This suit designation as part of the predefined condition may randomly change among the four suits (or other types of conditions), or may be something that the player can set or change.

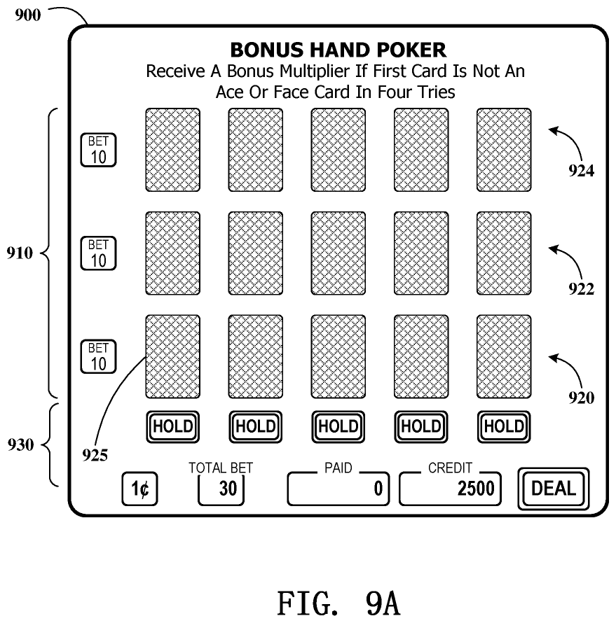

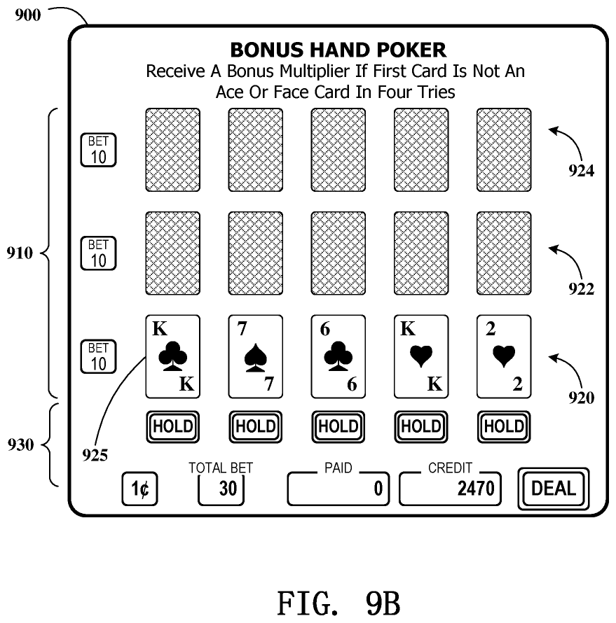

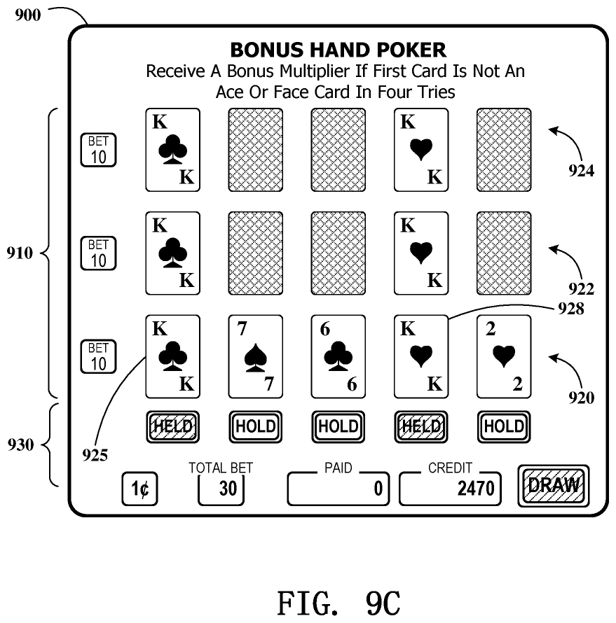

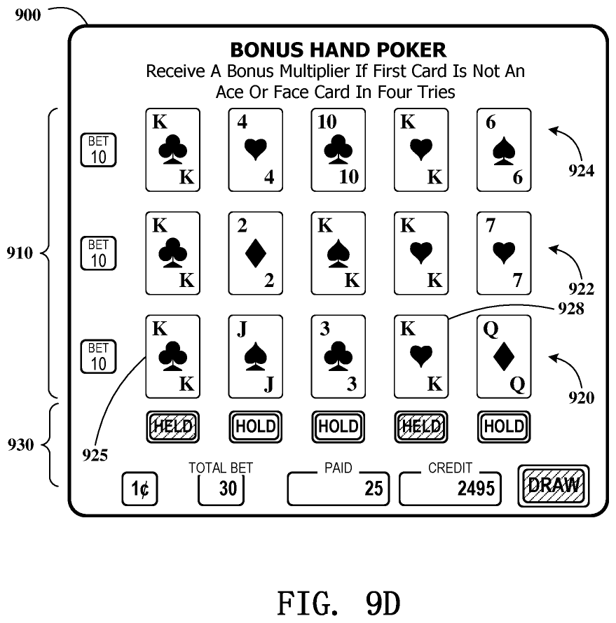

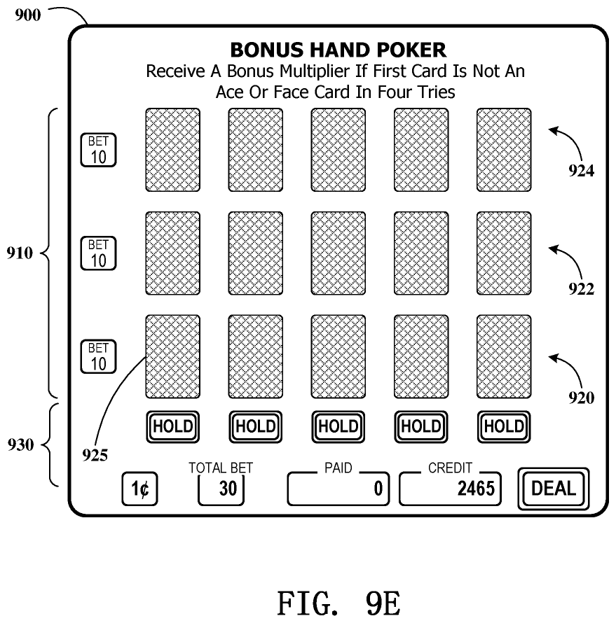

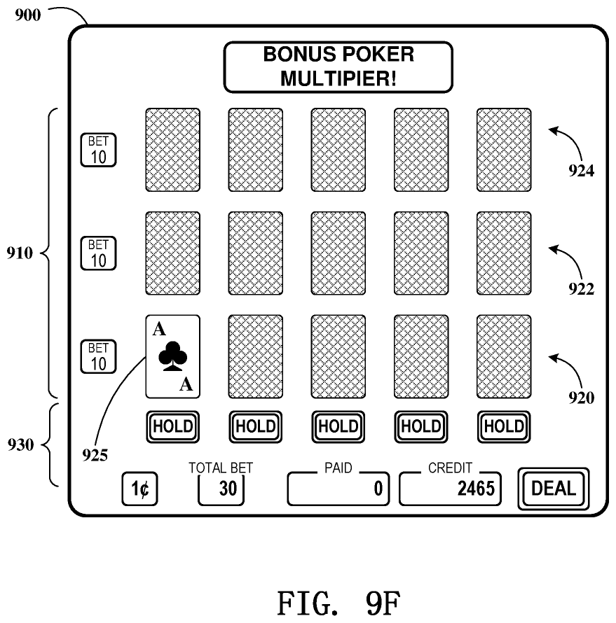

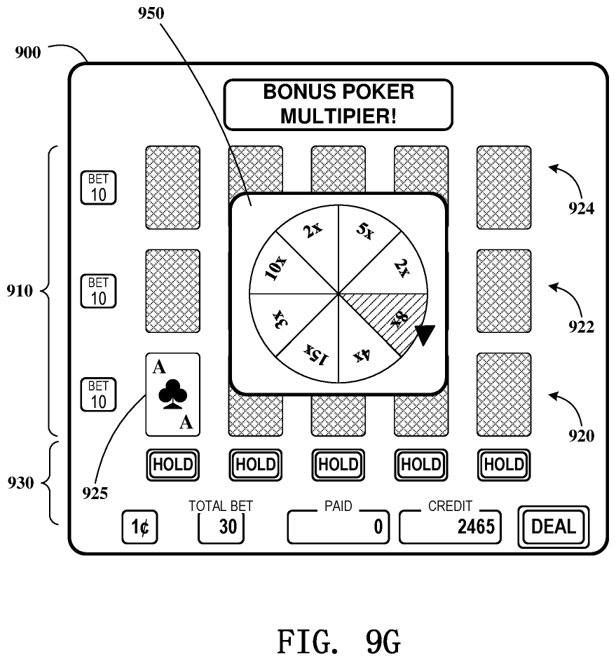

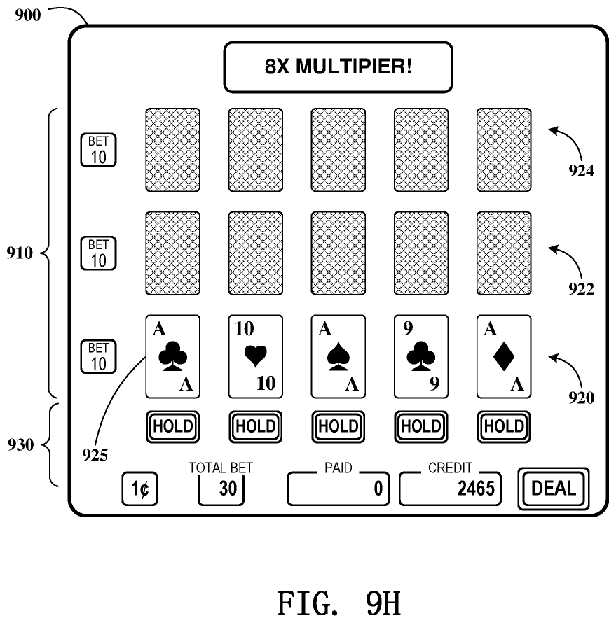

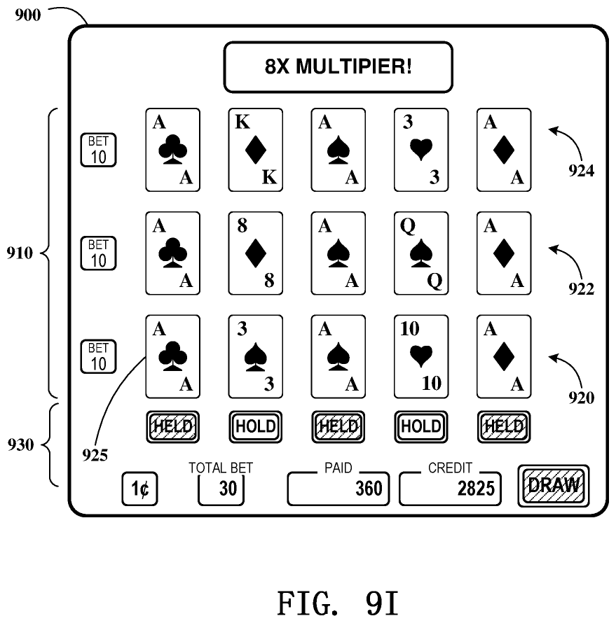

FIGS. 9A, 9B, 9C, 9D, 9E, 9F, 9G, 9H, and 9I are detail diagrams of a gaming device display showing a game progression according to embodiments of the invention. This game progression illustrates a multi-hand poker gaming event that uses the enhanced starting feature, as well as the amount of the bonus multiplier being randomly determined by a side bonus game, which in this case is a bonus wheel with various multiplier values.

Referring to FIG. 9A, a gaming device display 900 includes a game play area 910 configured to display a grid of card positions making up a first poker hand 920, a second poker hand 922 and a third poker hand 924 as part of the poker game, and a player interface area 930 showing various buttons, meters, and/or information to allow the player to interact with the poker game on the gaming device. Here, the gaming device is configured so that the virtual card shown in the first card position 925 of the first poker hand 920 must meet a predefined condition. In this particular embodiment, the predefined condition specifies that the virtual card in the first card position 925 must be one of the ace or face cards. In addition, the poker game includes a bonus feature where if the first four cards in the random sequence are not ace or face cards a bonus multiplier will be applied to any awards won based on the final poker hands of the poker game.

Referring to FIG. 9B, one of the first three cards examined in the random sequence of cards meets the predefined condition as the King of Clubs is an ace or face card. Additionally, the remaining cards in the first poker hand are dealt in the remaining card positions of the first poker hand 920 to complete a first dealt poker hand. The player may not know how many cards were examined in the random sequence before one was found to satisfy the predefined condition (or at least not know if one, two, or three cards were examined, as there was no bonus multiplier awarded). Referring to FIG. 9C, the player holds the KC in the first card position 925 and the KH in the fourth card position 928 as they form a pair. These held cards are then copied into the second poker hand 922 and third poker hand 924 as shown in FIG. 9C. Referring to FIG. 9D, after the player hits the Draw button, the non-held cards in the first poker hand 920 are replaced with new virtual playing cards and the remaining card positions in the second poker hand 922 and 924 are filled with random virtual cards. In some embodiments, separate decks of cards are used for each of the first, second and third poker hands 920, 922, 924. Each of these final poker hands in then evaluated for awards and that first poker game (or first gaming event) is over.

Referring to FIG. 9E, a second poker game (or second gaming event) is initiated. Referring to FIG. 9F, more than four cards are examined in the random card sequence before an Ace of Clubs (AC) is found and displayed in the first card position 925 of the first poker hand 920. It is known that more than four cards were examined as the game display 900 indicates a message that a bonus feature to determine a bonus multiplier has been triggered. Referring to FIG. 9G, a bonus feature is shown in a bonus display area 950 where a bonus wheel with multiple possible bonus multipliers is shown. This bonus wheel is spun in the bonus display area 950 and the resulting bonus multiplier is then shown on the game display 900 as shown in FIG. 9H. In addition, as the predefined condition has been satisfied for the first card position 925, the remaining card positions in the first poker 920 hand are filled with cards from the random sequence of cards to form a first dealt poker hand. Referring to FIG. 9I, after cards are held in the first poker hand 920, additional cards are used to replace any non-held cards in the first poker hand, and random cards are respectively dealt to the second and third poker hands 922, 924 from separate poker decks to form three final poker hands. These three final poker hands are then evaluated for awards. Any determined total award from these three final poker hands is then multiplied by the bonus multiplier, and the credit amount stored in the memory of the gaming device is increased by that multiplied award amount.

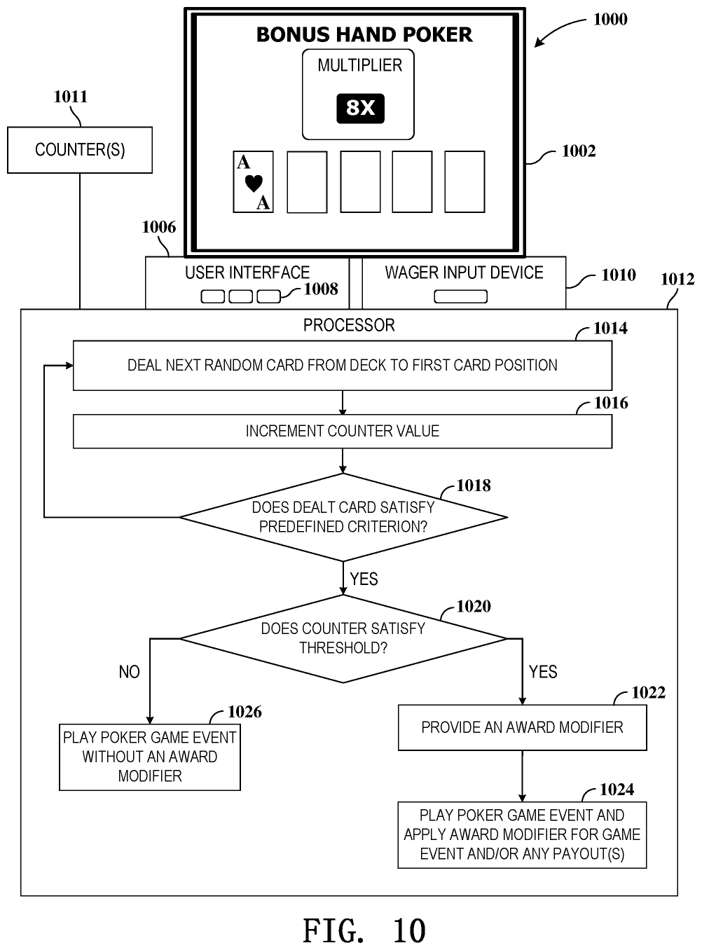

FIG. 10 is a block diagram of a representative gaming apparatus for providing an enhanced start feature according to embodiments of the invention. FIG. 10 and any other diagrams depicting a process flow represent operations in which a gaming device and/or gaming system can be operated according to representative embodiments. Although various processes may be depicted in a particular order, the order of these operations can be changed in other embodiments without deviating from the scope or spirit of this concept. Accordingly, the order of the processes shown is for illustrative purposes only and is not meant to be restrictive. Additional game processes may also be included between various processes even though they are not shown in these operational processes for purposes of clarity. The operations or processes may be performed by components in a single game device, such as by a game processor(s), or may be performed in part or whole by a remote server or processor(s) connected to the gaming device via a network. Each operation or process may be encoded in instructions that are stored in one or more memories, a computer-readable medium(s), or another type of storage device(s). The exemplary operations and methodologies depict representative embodiments of how game operations may be implemented. As discussed herein, many variations exist which may require additional, fewer, or different processes to complete.

Referring to FIG. 10, a gaming device 1000 may include a game display 1002, a user interface panel 1006 including one or more physical buttons 1008, a wager input device 1010, one or more counters 1011, and a processor 1012. The processor 1012 may be operable to perform various processes in connection with the other components of the gaming device 1000. In this embodiment, the processor 1012 is configured to deal and examine a first or next random card from a deck of virtual playing cards for a first card position in process 1014. The counter 1011 may increment a counter value for each card examined by the processor 1012 in process 1014 as part of process 1016. In process 1018, the processor determines if the examined card satisfies a predefined condition (or predefined criterion). If the examined card does not satisfy the predefined condition, the processor 1012 returns to process 1014 to examine the next card in the sequence. On the other hand, if the examined card does satisfy the predefined condition, the processor 1012 moves to process 1020 to see if the counter value satisfies a threshold. If the counter values does not satisfy the threshold, the processor 1012 moves to process 1026 and the poker game event is played without a bonus modifier. If, on the other hand, the counter value does satisfy the threshold, the processor 1012 moves to process 1022 when an award modifier is determined, followed by process 1024 where the poker game event is played with the bonus modifier applied to the poker game event and/or any awards or payouts.

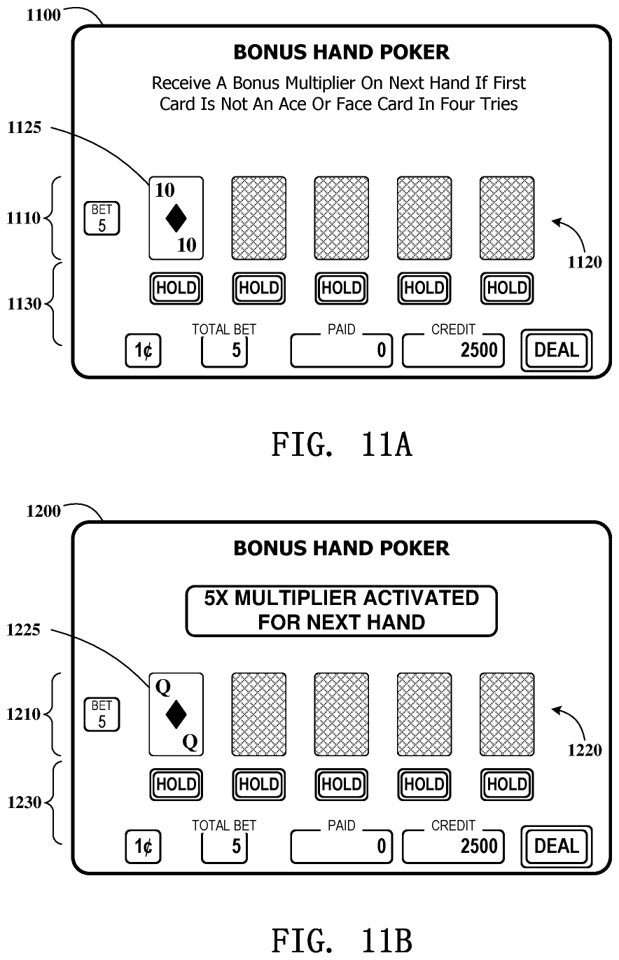

FIGS. 11A and 11B are detail diagrams of a gaming device display showing a game progression according to embodiments of the invention. In this example game progression, a bonus modifier is awarded for a next poker hand when a predetermined number of cards in the random sequence do not meet a predefined condition.

Referring to FIG. 11A, a gaming device display 1100 includes a game play area 1110 configured to display a grid of card positions making up one or more poker hands 1120 as part of the poker game, and a player interface area 1130 showing various buttons, meters, and/or information to allow the player to interact with the poker game on the gaming device. Here, the gaming device is configured so that the virtual card shown in the first card position 1125 of the poker hand 1120 must meet a predefined condition. In this particular embodiment, the predefined condition specifies that the virtual card in the first card position 1125 must be an ace or face card. In addition, the poker game includes a bonus feature where if the first four cards in the random sequence are not ace or face cards a bonus multiplier will be initiated and applied to a future poker game, such as the next played poker game (or poker gaming event). In some embodiments, a bonus modifier may be applied both to the current poker game and to the next poker game (and possibly additional future poker games).

Referring to FIG. 11B, a virtual card from a random sequence of cards is displayed in the first card position 1125 and the processor determines if that virtual card satisfies the predefined condition. In this case the Queen of Diamonds (QD) is a face card and hence satisfies the predefined condition. In addition, at least four cards were examined as a 5× multiplier has been indicated on the game display 1100 as being awarded for the next poker game.

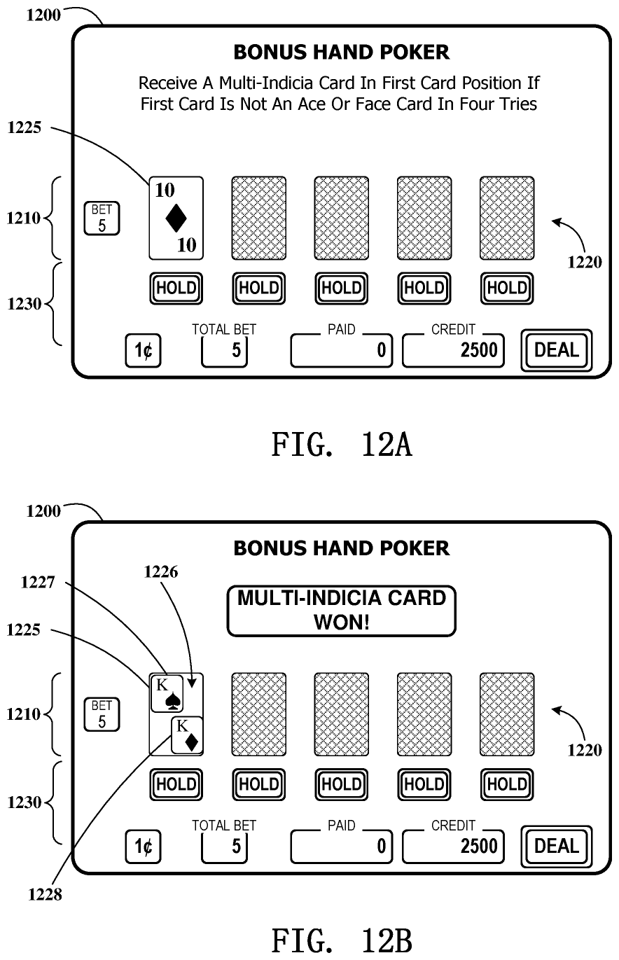

FIGS. 12A and 12B are detail diagrams of a gaming device display showing a game progression according to embodiments of the invention. In this example game progression, the bonus modifier award is a multi-indicia card being awarded where a predetermined number of cards in the random sequence do not meet a predefined condition.

Referring to FIG. 12A, a gaming device display 1200 includes a game play area 1210 configured to display a grid of card positions making up one or more poker hands 1220 as part of the poker game, and a player interface area 1230 showing various buttons, meters, and/or information to allow the player to interact with the poker game on the gaming device. Here, the gaming device is configured so that the virtual card shown in the first card position 1225 of the poker hand 1220 must meet a predefined condition. In this particular embodiment, the predefined condition specifies that the virtual card in the first card position 1225 must be an ace or face card. In addition, the poker game includes a bonus feature where if the first four cards in the random sequence are not ace or face cards a bonus modifier in the form of a multi-indicia card will applied to card in the first card position. In some embodiments, this multi-indicia card may comprise the card in the sequence that satisfied the predefined condition and the next card in the random sequence. This in essence, gives the player six cards to make the best five card poker hand. In other embodiments, the multi-indicia card may use the card that satisfied the predefined condition plus an additional card based on a predetermined rule. For example, the predetermined rule may specify that the second card shown on the multi-indicia card is of the same rank or of the same suit and being one away in rank as the first card shown on the multi-indicia card.

Referring to FIG. 12B, a virtual card 1227 from a random sequence of cards is displayed in the first card position 1225 and the processor determines if that virtual card satisfies the predefined condition. In this case, the virtual card 1227 is the King of Spades (KS) which is a face card and hence satisfies the predefined condition. In addition, at least four cards were examined as the KS has been modified into a multi-indicia card 1226 by adding the King of Hearts (KH) 1228 to the same multi-indicia card in the first card position 1225 for use in the first poker hand 1220.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out herein and reflected in the claims below.

1. A gaming device comprising:
a display including a video screen having a poker game play grid having a plurality of card positions;
a player interface including at least one button, the button configured to generate a signal in response to being activated;
a memory configured to store a deck of virtual cards and a credit amount;
a wager input device structured to receive physical items associated with currency values; and
a processor operable to:
receive a signal indicating receipt of a physical item associated with a currency value;
increase the credit amount stored in the memory based on the currency value associated with the received physical item;
receive a game initiation signal including a wager amount to initiate a poker gaming event, the wager amount deducted from the credit amount stored in the memory;
randomly determine a sequence of virtual playing cards to use in the poker gaming event from the deck of virtual playing cards stored in the memory of the gaming device;
determine, starting at a first virtual card of the randomly determined sequence:
(a) whether an examined virtual playing card meets a predefined condition,
(b) displaying the examined virtual playing card in a first card position of the game play grid if the virtual playing card satisfies the predefined condition,
(c) examining a next card in the randomly determined sequence if the virtual player card does not satisfy the predefined condition, and
(d) repeating steps (a)-(c) until the virtual playing card satisfies the predefined condition;
deal virtual cards from the randomly determined sequence to the remaining card positions in the plurality of card positions in the poker game play grid to complete a dealt poker hand;
receive signals to hold cards in the dealt poker hand;
replace any non-held cards in the dealt poker hand with replacement cards from the randomly determined sequence to complete a final poker hand;
evaluate the final poker hand for awards; and
increase the credit amount stored in the memory based on any awards determined from the evaluation of the final poker hand.
